(19) United States
(12) Patent Application Publication
(10) Pub. No.: US 2008/0123508 A1
(43) Pub. Date: May 29, 2008

(54) Write Correction Circuit and Write Correction Signal Generating Method

(75) Inventors: Kouichi Nagano, Osaka (JP); Hiroyuki Nakahira, Kyoto (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kodoma-shi (JP)

(21) Appl. No.: 11/666,664

(22) PCT Filed: Sep. 27, 2005
(86) PCT No.: PCT/JP05/17750

§ 371 Date: May 1, 2007

(30) Foreign Application Priority Data
Nov. 11, 2004 (JP) 2004-327992

(51) Int. Cl. G11B 7/00

(52) U.S. Cl. 369/116

(57) ABSTRACT

Conventional signal write correction circuits involve a problem that when n-phase clock is selected, the waveform may be distorted in high speed operation if the last-phase clock is selected. Two delay selection circuits (16a, 16b) select the odd-numbered edges and the even-numbered edges of a multipulse signal used for write correction. To select the edges, each of the delay selection circuits (16a, 16b) uses two enable signals. The exclusive OR of the outputs of the two delay selection circuits (16a, 16b) is taken to generate the timing of the multipulse signal.

### TECHNICAL FIELD

The present invention relates to an information recording apparatus which employs an information recording medium to which information can be recorded by irradiation of laser beam, and particularly to a write correction circuit for an optical information recording apparatus for controlling a laser driven waveform, and a method for generating a write correction signal.

### BACKGROUND ART

In a conventional method for writing to and erasing from a rewritable recording film, a write control is performed to a recording energy beam at a plural of power levels, and a write control is performed to the time axis direction at a plural of pulse durations, and a write control is performed according to patterns of recording marks and spaces at before and behind (e.g., see patent documents 1,2,3, and 4).

FIG. 8 is a diagram for illustrating a conventional writing system signal processing. In FIG. 8, numeral 1 denotes a write correction circuit, numeral 2 denotes an optical disk, numeral 3 denotes a motor, numeral 4 denotes an optical head, numeral 5 denotes a system controller for controlling the write correction circuit 1, the motor 3, and the optical head 4, and numeral 6 denotes a laser driver circuit.

Further, FIG. 9 is a block diagram for illustrating the construction of the write correction circuit 1 shown in FIG. 8. In FIG. 9, numeral 7 denotes a space/mark length detection circuit, numeral 8 denotes an address generation and timing control circuit, numeral 9 denotes a multiphase signal output circuit, and numeral 10 denotes a timing generation circuit.

Hereinafter, the operation of a conventional write correction circuit constituted as above will be explained.

The optical disk 2 is rotated by the motor 3 at a constant liner speed. Information recorded on the optical disk 2 is read out by the optical head 4. At writing, after recorded waveform information transmitted through the system controller 5 is corrected by the write correction circuit 1, the laser drive circuit 6 writes recording marks on the optical disk 2 by emitting semiconductor laser in the optical head. In the write correction circuit 1, the space/mark length detection circuit 7 detects lengths of a space and a mark from a pulse signal which is inputted thereto, and in accordance with the space length and the mark length, the address generation and timing control circuit 8 generates a writing current value and a timing signal. Further, the multiphase signal output circuit 9 receives a clock signal, and generates a multiphase clock signal. The timing generation circuit 10 receives a multiphase clock signal outputted from the multiphase signal output circuit 9 and an output from the address generation and timing control circuit 8, and generates a write correction signal.

FIG. 10 is a block diagram for illustrating the construction of the timing generation circuit 10 shown in FIG. 9. In FIG. 10, numeral 11 denotes a timing sequence circuit, numeral 12 denotes a delay amount selection circuit, and numeral 13 denotes an output generation circuit.

The timing sequence circuit 11 coincides a power signal and a delay amount signal respectively to one-to-one ratio according to timing information received from the address generation and timing control circuit 8, and outputs the signals along the order of the write correction. The delay amount selection circuit 12 selects a clock having a desired phase from multiphase clock signals outputted from the multiphase signal output circuit 9 by a delay amount signal outputted from the timing sequence circuit 11, and outputs the clock. The output generation circuit 13 outputs a write correction signal comprising a multipulse signal by using the edge of the power signal outputted from the timing sequence circuit 11 and the output signal from the delay amount selection circuit 12.

The waveforms of these output signals are shown in FIG. 11.

### Patent document 1: Patent No. 2563322

### Patent document 2: Patent No. 2650940

### Patent document 3: Japanese Published Patent Hei.11-86291

### Patent document 4: Japanese Published Patent Hei.11-283249

### DISCLOSURE OF THE INVENTION

### Problems to be Solved by the Invention

In FIG. 12, an enable signal, a multiphase clock signal, and a signal of the delay edges of the delay amount selection circuit 12 are shown.

The multiphase clock with n-phases comprises n-signals with 0 to n−1 phases, and selects one signal therefrom at the period of an enable signal by a timing signal. FIG. 12(a) illustrates a case in which a phase of the multiphase clock smaller than (n−1)/2 is selected, and FIG. 12(b) illustrates a case in which a phase of a multiphase clock larger than (n−1)/2 is selected. In the case of FIG. 12(b), when (n−1)th phase as the last phase of the multiphase clock is selected, for example, since an output (delay edge) of the delay amount selection circuit 12 becomes like A that has a narrow pulse width, the waveform is distorted in high-speed operation, and thereby an appropriate write correction signal may not be generated.

The present invention is made to solve the above described problems, and has an object to obtain a write correction circuit which generates an appropriate write correction signal in high-speed recording operation, and further to obtain a write correction signal generation method which generates an appropriate write correction signal in high-speed recording operation.

### Measures to Solve the Problems

In order to solve the above problems, a write correction circuit according to the present invention (claim 1) is a write correction circuit for generating and outputting a write correction signal comprising a multipulse signal that is used for write correction, comprising: a signal distribution circuit which receives a timing signal, a delay amount signal indicating a delay amount of each edge for said multipulse signal with relative to said timing signal, and a power signal indicating a power of each pulse for said multipulse signal, respectively, and distributes these signals to subsequent circuits; a first delay selection circuit which receives said timing signal and said delay amount signal indicating a delay amount of an odd-numbered edge for said multipulse signal with relative to said timing signal, which are outputted from the signal distribution circuit, and a multiphase clock signal, and selects edge of said multiphase clock signal with using said delay amount signal, a second enable signal having a prescribed length and a first enable signal having a length longer than said second enable signal which are generated from said timing signal, to generate an odd-numbered edge for said multipulse signal; and a second delay selection circuit which receives said timing signal, and said delay amount signal indicating a delay amount of an even-numbered edge for said multipulse signal with relative to said timing signal, which are outputted from the signal distribution circuit, and a multiphase clock signal, and selects edge of said multiphase clock signal with using said delay amount signal, a second enable signal having a prescribed length and a first enable signal having a length longer than said second enable signal which are generated from said timing signal, to generate an even-numbered edge for said multipulse signal.

Thereby, it is possible to realize a highly precise write correction circuit which can avoid occurrence of distortion of waveforms during high-speed operation.

Further, according to the present invention (claim 2), in the write correction circuit as defined in claim 1, there is provided an exclusive OR circuit which takes an exclusive OR of the outputs from the first and the second delay selection circuit and outputs a write correction timing signal.

Thereby, it is possible to realize a highly precise write correction circuit which can avoid occurrence of distortion of waveforms during high-speed operation.

Further, according to the present invention (claim 3), in the write correction circuit as defined in claim 2, there is provided an output generation circuit for generating a write correction signal comprising a multipulse signal with using the both rising and falling edges of the output of the exclusive OR circuit.

Thereby, it is possible to realize a highly precise write correction circuit which can avoid occurrence of distortion of waveforms during high-speed operation.

Further, according to the present invention (claim 4), in the write correction circuit as defined in any of claims 1 to 3, the first and the second delay selection circuits respectively make pass or hold the multiphase clock signal by using the first enable signal having a length of two periods, and detect an edge of the multiphase clock signal by using the second enable signal having a length of one period.

Thereby, it is possible to realize a highly precise write correction circuit which can avoid occurrence of distortion of waveforms during high-speed operation.

Further, according to the present invention (claim 5), in the write correction circuit as defined in any of claims 1 to 3, the first and the second delay selection circuits respectively make pass or hold the multiphase clock signal by using the first enable signal having a length of three periods, and detect an edge of the multiphase clock signal by using the second enable signal having a length of one period.

Thereby, it is possible to realize a highly precise write correction circuit which can avoid occurrence of distortion of waveforms during high-speed operation.

Further, according to the present invention (claim 6), in the write correction circuit as defined in any of claims 1 to 3, the first and the second delay selection circuits respectively make pass or block the multiphase clock signal by using the first enable signal having a length of three periods, and detect an edge of the multiphase clock signal by using the second enable signal having a length of one period.

Thereby, it is possible to realize a highly precise write correction circuit which can avoid occurrence of distortion of waveforms during high-speed operation.

Further, according to the present invention (claim 7), in the write correction circuit as defined in claim 5 or 6, the second enable signal having a length of one period is enabled with synchronized with one period at the center of the first enable signal having a length of three periods.

Thereby, it is possible to realize a highly precise write correction circuit which can avoid occurrence of distortion of waveforms during high-speed operation.

Further, according to the present invention (claim 8), in the write correction circuit as defined in any of claims 1 to 3, the first and the second delay selection circuits respectively comprise a selection circuit for selecting a length of either two periods or three periods as the length of the first enable signal, and make pass or hold the multiphase clock signal by using the first enable signal having a length of two periods or three periods selected by the selection circuit, and detect an edge of the multiphase clock signal by using the second enable signal having a length of one period.

Thereby, it is possible to realize a highly precise write correction circuit which can avoid occurrence of distortion of waveforms during high-speed operation. Further it is possible to make the lengths of the first enable signal different depending on respective modes.

Further, a write correction signal generation method according to the present invention (claim 9) is a write correction signal generation method for generating a write correction signal comprising a multipulse signal which is used for write correction, comprising: a signal distribution process which receives a timing signal, a delay amount signal indicating a delay amount of each edge for the multipulse signal with relative to the timing signal, and a power signal indicating a power of each pulse for the multipulse signal, respectively, and distributes these signals to subsequent circuits; a first delay selection process which receives said timing signal, said delay amount signal indicating a delay amount of an odd-numbered edge for the multipulse signal with relative to the timing signal, which are outputted by the signal distribution process, and a multiphase clock signal, and selects an edge of the multiphase clock signal with using the delay amount signal, a second enable signal having a prescribed length and a first enable signal having a length longer than the second enable signal which are generated from the timing signal, to generate an odd-numbered edge for the multipulse signal; and a second delay selection process which receives said timing signal, said delay amount signal indicating a delay amount of an even-numbered edge for the multipulse signal with relative to the timing signal, which are outputted by the signal distribution process, and a multiphase clock signal, and selects an edge of the multiphase clock signal with using the delay amount signal, a second enable signal having a prescribed length and a first enable signal having a length longer than the second enable signal which are generated from the timing signal, to generate an even-numbered edge for the pulse signal.

Thereby, it is possible to avoid occurrence of distortion of waveforms during in high-speed operation, also to generate a write correction signal highly precisely.

Further, according to the present invention (claim 10), in the write correction signal generation method as defined in claim 9, there is included an exclusive OR process which takes an exclusive OR of the outputs generated by the first and the second delay selection process and outputs a write correction timing signal.

Thereby, it is possible to avoid occurrence of distortion of waveforms during in high-speed operation, also to generate a write correction signal highly precisely.

Further, according to the present invention (claim 11), in the write correction signal generation method as defined in claim 9, there is included an output generation process for generating a write correction signal comprising a multipulse signal with using the both rising and falling edges of the output obtained in the exclusive OR process.

Thereby, it is possible to avoid occurrence of distortion of waveforms during in high-speed operation, also to generate a write correction signal highly precisely.

Further, according to the present invention (claim 12), in the write correction signal generation method as defined in any of claims 9 to 11, in the first and the second delay selection processes respectively, the multiphase clock signal is made pass or held by the first enable signal having a length of two periods, and an edge of the multiphase clock signal is detected by the second enable signal having a length of one period.

Thereby, it is possible to avoid occurrence of distortion of waveforms during in high-speed operation, also to generate a write correction signal highly precisely.

Further, according to the present invention (claim 13), in the write correction signal generation method as defined in any of claims 9 to 11, in the first and the second delay selection processes respectively, the multiphase clock signal is made pass or held by the first enable signal having a length of three periods, and an edge of the multiphase clock signal is detected by the second enable signal having a length of one period.

Thereby, it is possible to avoid occurrence of distortion of waveforms during in high-speed operation, also to generate a write correction signal highly precisely.

Further, according to the present invention (claim 14), in the write correction signal generation method as defined in any of claims 9 to 11, in the first and the second delay selection processes respectively, the multiphase clock signal is made pass or blocked by the first enable signal having a length of three periods, and an edge of the multiphase clock signal is detected by the second enable signal having a length of one period.

Thereby, it is possible to avoid occurrence of distortion of waveforms during in high-speed operation, also to generate a write correction signal highly precisely.

Further, according to the present invention (claim 15), in the write correction signal generation method as defined in claim 13 or 14, the second enable signal having a length of one period is enabled with synchronized with one period at the center of the first enable signal having a length of three periods.

Thereby, it is possible to avoid occurrence of distortion of waveforms during in high-speed operation, also to generate a write correction signal highly precisely.

Further, according to the present invention (claim 16), in the write correction signal generation method as defined in any of claims 9 to 11, the first and second delay selection processes respectively include a selection process for selecting a length of either two periods or three periods as the length of the first enable signal, the multiphase clock signal is made pass or held by the first enable signal having a length of two periods or three periods selected in the selection process, an edge of the multiphase clock signal is detected by the second enable signal having a length of one period.

Thereby, it is possible to avoid occurrence of distortion of waveforms during in high-speed operation, also to generate a write correction signal highly precisely. Further it is possible to make the lengths of the first enable signal different depending on respective modes.

### Effects of the Invention

According to the present invention, in the write correction circuit for generating a write correction signal comprising a multipulse signal which is used for write correction, since the present invention has a construction in which two delay selection circuits respectively select the odd-numbered edge and the even-numbered edge of a multipulse signal that is used for write correction with using two enable signals, it is possible to realize a highly precise write correction circuit which can avoid occurrence of distortion of waveforms during high-speed operation.

### BRIEF DESCRIPTION OF THE DRAWING

FIG. 1 is a block diagram illustrating a construction of a timing generation circuit in the write correction circuit according to the first embodiment of the present invention.

FIG. 2 is a block diagram illustrating a construction of a delay selection circuit in the write correction circuit according to the first embodiment of the present invention.

FIG. 3 is a waveform chart for explaining the operation of the timing generation circuit in the write correction circuit according to the first embodiment of the present invention.

FIG. 4 is a waveform chart for explaining the operation of the write correction circuit according to the first embodiment of the present invention.

FIG. 5 is a block diagram illustrating a construction of a delay selection circuit in the write correction circuit according to the second embodiment of the present invention.

FIG. 6 is a waveform chart for explaining the operation of the timing generation circuit in the write correction circuit according to the second embodiment of the present invention.

FIG. 7 is a block diagram illustrating a construction of a delay selection circuit in the write correction circuit according to the third embodiment of the present invention.

FIG. 8 is a diagram illustrating a write system signal processing.

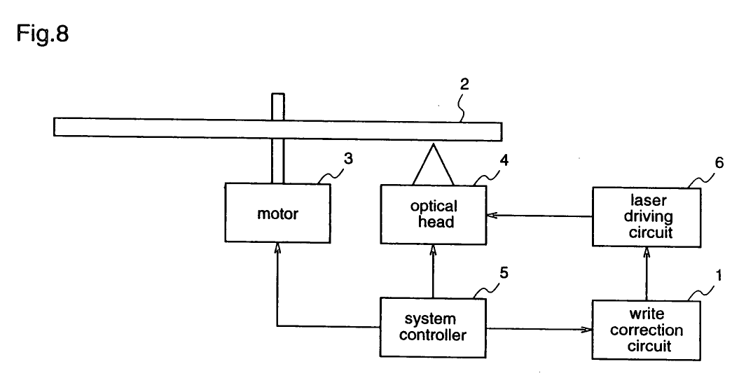

FIG. 9 is a diagram illustrating the entire construction of the write correction circuit.

FIG. 10 is a block diagram illustrating a timing generation circuit in a conventional write correction circuit.

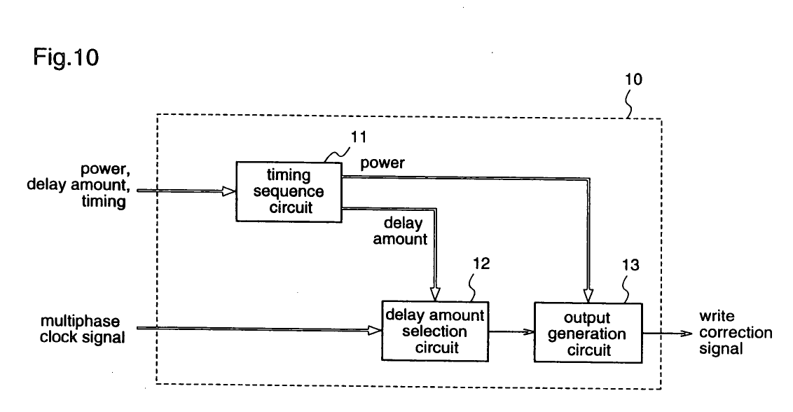

FIG. 11 is a waveform chart for explaining an operation of a conventional write correction circuit.

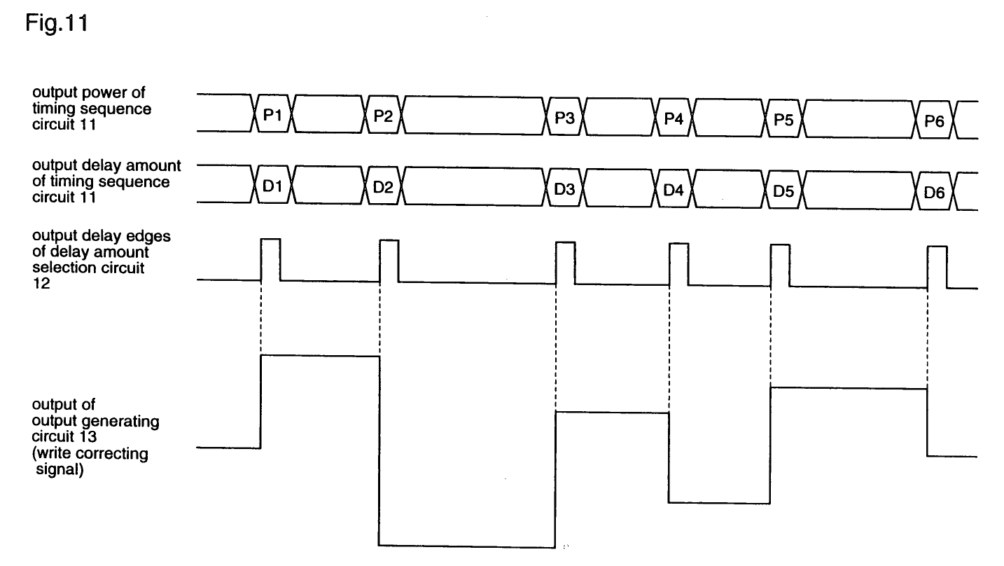

FIG. 12 is a waveform chart for explaining an operation of a delay selection circuit in a conventional write correction circuit.

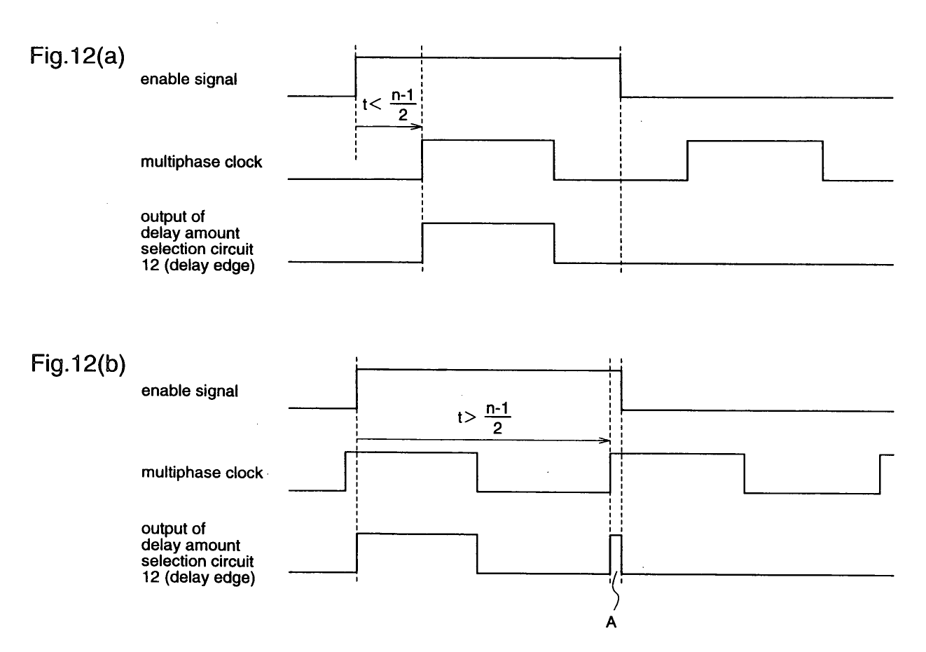

### DESCRIPTION OF REFERENCE NUMERALS

1 . . . write correction circuit
2 . . . optical disc
3 . . . motor
4 . . . optical head
5 . . . system controller
6 . . . laser driving circuit
7 . . . space/mark length detection circuit
8 . . . address generation and timing control circuit
9 . . . multiphase signal generation circuit
10 . . . timing generation circuit
11 . . . .timing sequence circuit
12 . . . delay amount selection circuit
13, 13b . . . output generation circuit
14 . . . signal distribution circuit
15, 150, 150a, 150b . . . delay circuit
16, 16a, 16b . . . delay amount selection circuit
17 . . . exclusive OR circuit

### 18 . . . OR circuit

19 . . . delay output circuit
20 . . . selection circuit

### BEST MODE FOR CARRYING OUT THE INVENTION

Hereinafter, the embodiments of the present invention will be described with reference to figures.

### First Embodiment

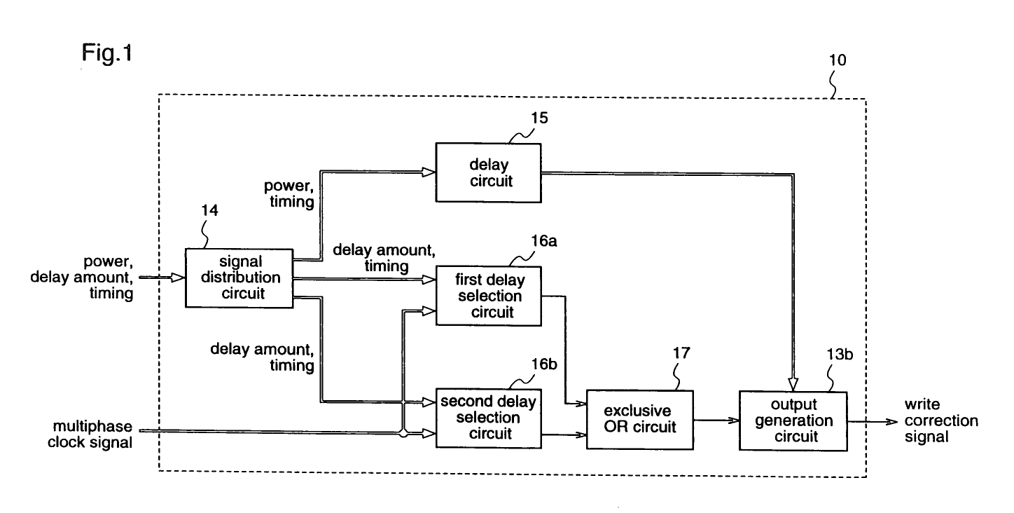

A write correction circuit according to the first embodiment of the present invention will be described with reference to FIGS. 1, 2, 3, and 4.

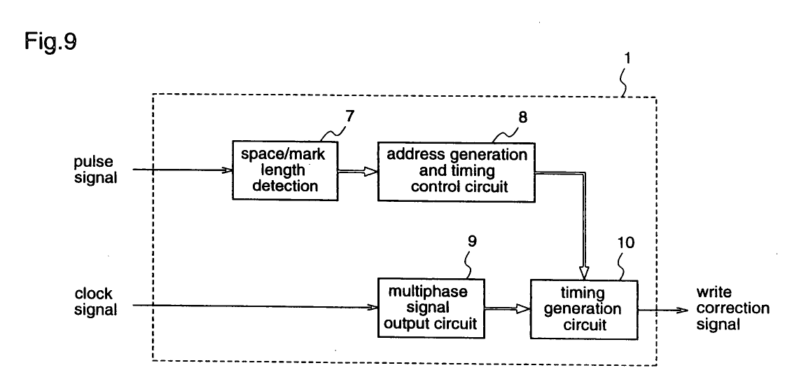

The write correction circuit of this first embodiment has a construction similar to that of the write correction circuit 1 shown in FIG. 9, while has the timing generation circuit 10 which is constituted differently. FIG. 1 is a block diagram illustrating the construction of the timing generation circuit 10 in the write correction circuit 1 of this first embodiment. In FIG. 1, numeral 14 denotes a signal distribution circuit, 15 denotes a delay circuit, 16a denotes a first delay selection circuit, 16b denotes a second delay selection circuit, 17 denotes an exclusive OR circuit, and 13b denotes an output generation circuit.

Next, the operation will be described.

The signal distribution circuit 14 receives a power signal, a delay signal, and a timing signal as input signals, and outputs a delay amount signal and a timing signal to two delay selection circuits 16a, 16b at alternate timings. Specifically, the circuit 14 outputs, to the first delay selection circuit 16a, a delay amount signal indicating a delay amount of an odd-numbered edge for a multipulse signal used for write correction and a timing signal, and outputs, to the second delay selection circuit 16b, a delay amount signal indicating a delay amount of an even-numbered edge for the multipulse signal used for write correction and a timing signal. In addition, the signal distribution circuit 14 outputs a power signal and a timing signal to the delay circuit 15. The delay selection circuit 16 selects a delay signal from multiphase signals by using the delay signal and the timing signal, to output the same. An exclusive OR of the outputs from the two delay selection circuits 16a, 16b is taken by the exclusive OR circuit 17, and finally, a write correction signal is outputted from the output generation circuit 13b with using the both rising and falling edges of the output from the exclusive OR circuit 17.

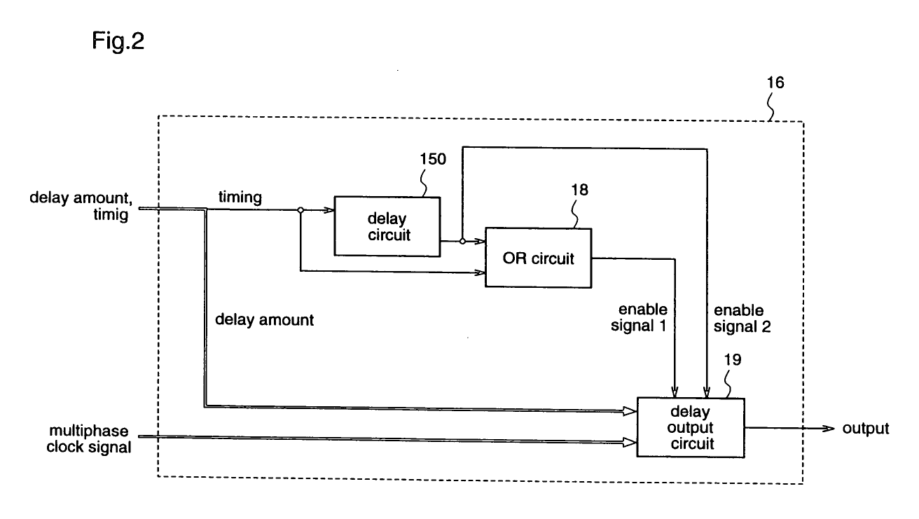

FIG. 2 is a block diagram illustrating the construction of the delay selection circuit 16. In FIG. 2, numeral 150 denotes a delay circuit, numeral 18 denotes an OR circuit, and numeral 19 denotes a delay output circuit.

The delay circuit 150 in FIG. 2 generates a second enable signal by delaying a timing signal which is inputted thereto. Further, the OR circuit 18 takes an OR of the outputs of the delay circuit 150 and a timing signal, to generate a first enable signal. As a result, the length of the first enable signal becomes a length of two periods and the length of the second enable signal becomes a length of one period. The delay output circuit 19 detects an edge of the delay signal by using these two enable signals.

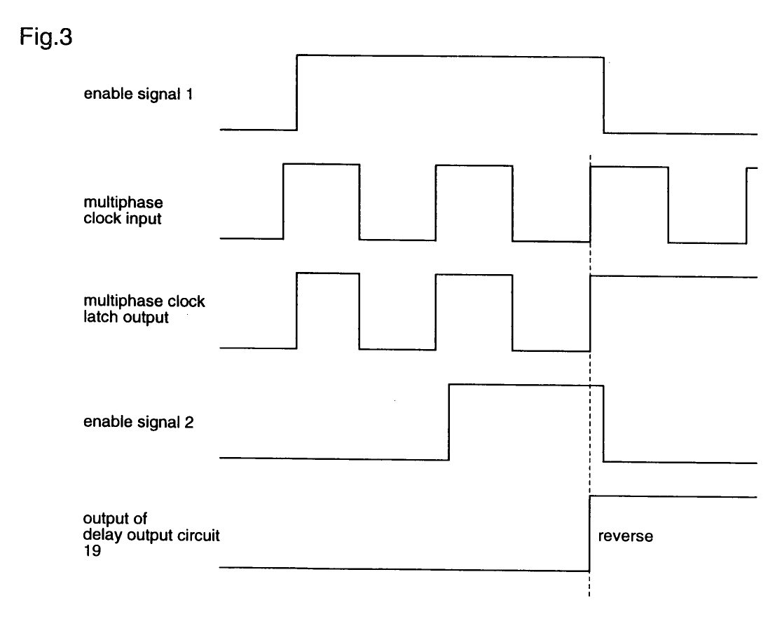

The waveforms of these output signals are shown in FIG. 3.

An input signal of the multiphase clock is made pass or held with the first enable signal. The input signal is made pass when the first enable signal is 1 (High) while it is held when the first enable signal is 0 (Low), and this is made a latch output of the multiphase clock. Then, from this latch output signal, an edge thereof is detected using the second enable signal. As a result, even when the last phase is selected during a high speed operation, it can be avoided that the waveform is distorted, and thereby realizing a precise write correction operation.

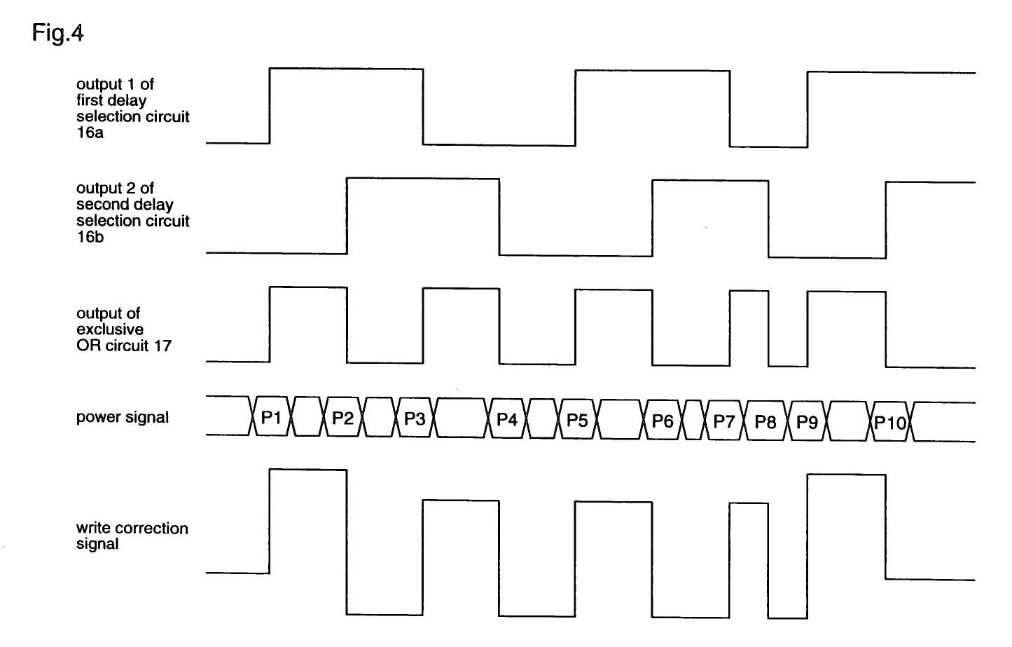

FIG. 4 shows the waveforms of the exclusive OR signal and the write correction signal which are outputted from the delay output circuits 16a, 16b.

As described above, according to this first embodiment, there are provided a signal distribution circuit 14 which receives a timing signal, a delay amount signal, and a power signal, and distributes these signals to subsequent circuits, a first delay selection circuit 16a which receives the timing signal, delay amount signal indicating delay amount of an odd-numbered edge for the multipulse signal, and the multiphase clock signal, and selects edge of the multiphase clock signal with using a second enable signal having a prescribed length that is generated from the delay amount signal and the timing signal and a first enable signal having a length longer than the second enable signal, and a second delay selection circuit which receives a timing signal, delay amount signals indicating delay amounts of even-numbered edges of the multipulse signal, and the multiphase clock signal, and selects edges of the multiphase clock signal with using a second enable signal having a predetermined length that is generated from the delay amount signal and the timing signal and a first enable signal having a length longer than the second enable signal. Therefore, a highly precise write correction circuit which can avoid occurrence of distortions during the high-speed operation is realized.

### Second Embodiment

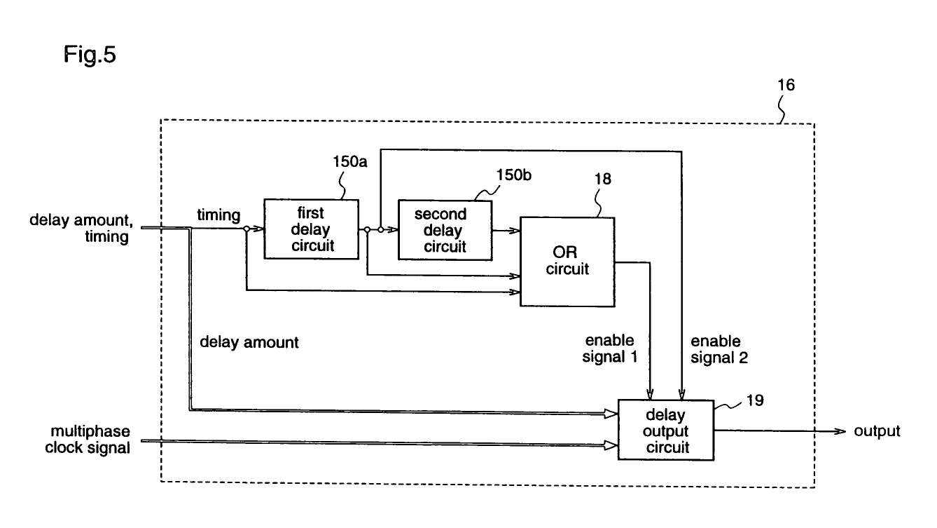

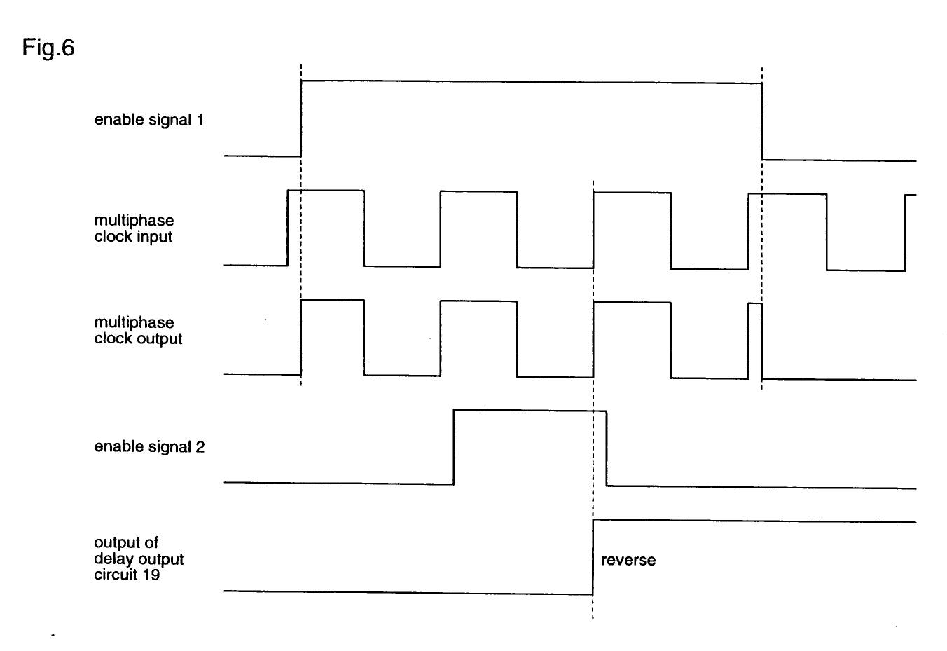

A write correction circuit according to the second embodiment of the present invention will be described with reference to FIGS. 5 and 6.

The write correction circuit according to the second embodiment has a construction for a delay selection circuit 16 that is different from that in the write correction circuit of the first embodiment, while the other construction is the same as in the write correction circuit of the first embodiment. FIG. 5 is a block diagram illustrating the construction of the delay selection circuit 16 in the write correction circuit according to this second embodiment. In FIG. 5, the same numerals as in FIG. 2 denote the same or corresponding portions, and numeral 150a denotes a first delay circuit, and numeral 150b denotes a second delay circuit.

Next, the operation will be described. Regarding FIG. 5, a description is omitted for the operation the same as the operation of FIG. 2. There are differences from FIG. 2 in that two delay circuits 150a, 150b are employed and that there are three inputs as inputs of the OR circuit 18.

The OR circuit 18 takes an OR of a timing signal and the outputs of the two delay circuits 150a, 150b, to generate a first enable signal. As a result, the length of the first enable signal becomes that of three periods, and the length of the second enable signal becomes that of one period as similarly as in the case of FIG. 2. by using these two enable signals, edges of the delay signal are detected by the delay output circuit 19.

The waveforms of these output signals are shown in FIG. 6.

As shown in FIG. 6, one period at the center of the three periods length of the first enable signal becomes the second enable signal, and an edge of a delay signal (multiphase clock output) is detected by using the second enable signal. While in the first embodiment one having a length of two periods is employed as a first enable signal and therefore the multiphase clock signal which is inputted to the delay output circuit 19 is required to be latched therein. However, since in this second embodiment the first enable signal is made of a signal that is a length of three periods and the multiphase clock signal is selected with using a second enable signal which is enabled at the timing of one period at the center of the three periods, the multiphase clock signal which is inputted to the delay output circuit 19 is not required to be latched therein, and thereby simplifying the circuit configuration of the delay output circuit 19.

As described above, according to this second embodiment, there are provided a signal distribution circuit 14 which receives a timing signal, a delay amount signal, and a power signal, and distributes these signals to subsequent circuits, a first delay selection circuit 16a which receives the timing signal, delay amount signal indicating delay amount of an odd-numbered edge for the multipulse signal which are outputted from the signal distribution circuit 14, and the multiphase clock signal, and selects edge of the multiphase clock signal with using a second enable signal having a prescribed length that is generated from the delay amount signals and the timing signal and a first enable signal having a length longer than the second enable signal, and a second delay selection circuit 16b which receives a timing signal, delay amount signal indicating delay amount of an even-numbered edge for the multipulse signal, and the multiphase clock signal, and selects edge of the multiphase clock signal with using a second enable signal having a predetermined length that is generated from the delay amount signals and the timing signal and a first enable signal having a length longer than the second enable signal similarly as in the first embodiment, and further, the first and the second delay selection circuits 16a and 16b are made pass or block the multiphase clock by the first enable signal which has a length of three periods and detect the edges of the multiclock signal by the second enable signal which is enabled at the timing of the center period among the three periods of the first enable signal and has a length of one period. Therefore, it is possible to realize a highly precise write correction circuit which can avoid occurrence of distortion of a waveform during high-speed operation as well as can simplify the circuit configuration of the delay output circuit 19 with relative to the first embodiment.

In addition, in this embodiment, the write correction circuit can be constructed such that a multiphase clock input signal is made pass or held by the first enable signal. In this case, similarly as in the first embodiment, the delay output circuit 19 is required to have a function of latching a multiphase signal which is inputted thereto. However, a highly precise write correction circuit which can avoid occurrence of distortion of waveforms during a high-speed operation is realized.

### Third Embodiment

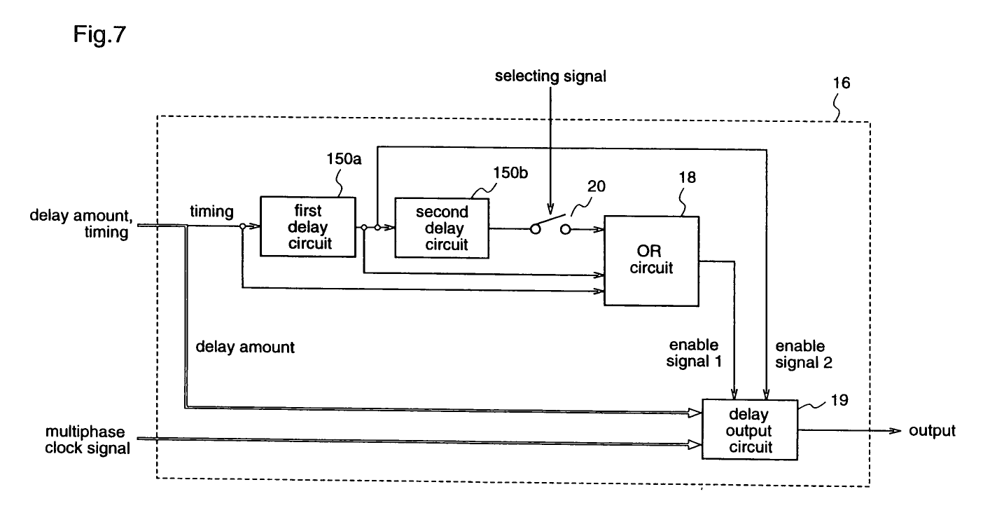

A write correction circuit according to the third embodiment of the present invention will be described with reference to FIG. 7.

The write correction circuit according to the third embodiment has a construction for a delay selection circuit 16 that is different from that in the write correction circuit of the first embodiment, while the other construction is the same as that in the write correction circuit of the first embodiment. FIG. 7 is a block diagram illustrating the construction of the delay selection circuit 16 in the write correction circuit of this third embodiment. In FIG. 7, the same numerals as in FIG. 5 denote the same or corresponding portions, numeral 150a denotes a first delay circuit, and numeral 150b denotes a second delay circuit, and numeral 20 denotes a selection circuit.

The delay selection circuit in the write correction circuit of this third embodiment in FIG. 7 is different from the delay selection circuit in the write correction circuit of the second embodiment in FIG. 5 in that the selection circuit 20 is disposed between the second delay circuit 150b and the OR circuit 18.

Next, the operation will be described. In the write correction circuit according to the third embodiment, by opening or closing the selection circuit 20 according to a selection signal from the outside, the inputs of the OR circuit 18 are made two inputs or three inputs. When the selection circuit 20 is opened, the inputs of the OR circuit 18 becomes two inputs, and the same operation as the delay selection circuit in the write correction circuit of the first embodiment in FIG. 2 is obtained. When the selection circuit 20 is closed, the inputs of the OR circuit 18 becomes three inputs, and the same operation as the delay selection circuit in the write correction circuit of the second embodiment in FIG. 5 is obtained. Thus, in the third embodiment, by switching open or close states of the selection circuit 20, it is possible to make the length of the first enable signal be two periods or three periods, and thereby it is further possible to make the lengths of the first enable signal different depending on respective modes.

As described above, according to this third embodiment, there are provided a signal distribution circuit 14 which receives a timing signal, a delay amount signal, and a power signal, and distributes these signals to subsequent circuits, a first delay selection circuit 16a which receives the timing signal, delay amount signal indicating delay amount of an odd-numbered edge for the multipulse signal which are outputted from the signal distribution circuit 14, and the multiphase clock signal, and selects edges of the multiphase clock signal with using a second enable signal having a prescribed length that is generated from the delay amount signals and the timing signal and a first enable signal having a length longer than the second enable signal, and a second delay selection circuit 16b which receives a timing signal, delay amount signal indicating delay amount of even-numbered edge for the multipulse signal, and the multiphase clock signal, and selects edges of the multiphase clock signal with using a second enable signal having a predetermined length that is generated from the delay amount signals and the timing signal and a first enable signal having a length longer than the second enable signal similarly as in the first embodiment, and further, the first and the second delay selection circuits 16a and 16b are provided with a selection circuit 20 which selects either of a length of two periods or a length of three periods as a length of the first enable signal, and designed to make pass or block the multiphase signal by the first enable signal having a length of two periods or three periods that is selected by the selection circuit 20, and detect edge of the multiphase clock signal by the second enable signal of the multiphase clock signal. Therefore, it is possible to realize a highly precise write correction circuit which can avoid occurrence of distortion of waveforms during high-speed operation as well as which can differently use the length of the first enable signal dependent on the respective modes.

### INDUSTRIAL APPLICABILITY

The write correction circuit of the present invention has a construction in which two delay selection circuits respectively select the odd-numbered edge and the even-numbered edge of a multipulse signal used for write correction with using two enable signals, respectively. Therefore, the present invention is very effective for use as an optical recording information apparatus or the like which performs write correction highly precisely. Further, it is also possible to apply the present invention communications or the like that require write correction.

1. A write correction circuit for generating and outputting a write correction signal comprising a multipulse signal that is used for write correction, the circuit comprises:
a signal distribution circuit which receives a timing signal, a delay amount signal indicating a delay amount of each edge for said multipulse signal with relative to said timing signal, and a power signal indicating a power of each pulse for said multipulse signal, respectively, and distributes these signals to subsequent circuits;
a first delay selection circuit which receives said timing signal, said delay amount signal indicating a delay amount of an odd-numbered edge for said multipulse signal with relative to said timing signal, which are outputted from said signal distribution circuit, and a multiphase clock signal, and selects an edge of said multiphase clock signal with using said delay amount signal, a second enable signal having a prescribed length and a first enable signal having a length longer than the second enable signal which are generated from said timing signal, to generate an odd-numbered edge for said multipulse signal; and
a second delay selection circuit which receives said timing signal, said delay amount signal indicating a delay amount of the even-numbered edge for said multipulse signal with relative to said timing signal, which are outputted from said signal distribution circuit, and a multiphase clock signal, and selects an edge of said multiphase clock signal with using said delay amount signal, a second enable signal having a prescribed length and a first enable signal having a length longer than the second enable signal which are generated from said timing signal, to generate an even-numbered edge for said multipulse signal.

2. The write correction circuit as defined in claim 1 which comprises an exclusive OR circuit which takes an exclusive OR of the outputs from said first and said second delay selection circuit and outputs a write correction timing signal.

3. The write correction circuit as defined in claim 2 which comprises an output generation circuit for generating a write correction signal comprising a multipulse signal with using the both rising and falling edges of the output from said exclusive OR circuit.

4. The write correction circuit as defined in claim 1, wherein said first and said second delay selection circuits respectively make pass or hold said multiphase clock signal by using said first enable signal having a length of two periods, and detect an edge of said multiphase signal by using said second enable signal having a length of one period.

5. The write correction circuit as defined in claim 1, wherein said first and said second delay selection circuits respectively make pass or hold said multiphase clock signal by using said first enable signal having a length of three periods, and detect an edge of said multiphase clock signal by using said second enable signal having a length of one period.

6. The write correction circuit as defined in claim 1, wherein said first and said second delay selection circuits respectively make pass or block said multiphase clock signal by using said first enable signal having a length of three periods, and detect an edge of said multiphase clock signal by using said second enable signal having a length of one period.

7. The write correction circuit as defined in claim 5, wherein said second enable signal having a length of one period is enabled with synchronized with one period at the center of said first enable signal having a length of three periods.

8. The write correction circuit as defined in claim 1, wherein said first and said second delay selection circuits respectively comprise a selection circuit for selecting a length of either two periods or three periods as the length of said first enable signal, and make pass or hold said multiphase clock signal by using said first enable signal having a length of two periods or three periods selected by the selection circuit, and detect an edge of said multiphase clock signal by using said second enable signal having a length of one period.

9. A write correction signal generation method for generating a write correction signal comprising a multipulse signal which is used for write correction, the method includes:
a signal distribution process which receives a timing signal, a delay amount signal indicating a delay amount of the edge for said multipulse signal with relative to said timing signal, and a power signal indicating a power of each pulse for said multipulse signal, and distributes these signals to subsequent circuits;
a first delay selection process which receives said timing signal, said delay amount signal indicating a delay amount of an odd-numbered edge for said multipulse signal with relative to said timing signal, which are outputted by said signal distribution process, and a multiphase clock signal, and selects an edge of said multiphase clock signal with using said delay amount signal, a second enable signal having a prescribed length and a first enable signal having a length longer than the second enable signal which are generated from said timing signal, to generate an odd-numbered edge for said multipulse signal; and
a second delay selection process which receives said timing signal, said delay amount signal indicating a delay amount of an even-numbered edge for said multipulse signal with relative to said timing signal, which are outputted by said signal distribution process, and a multiphase clock signal, and selects an edge of said multiphase clock signal with using said delay amount signal, a second enable signal having a prescribed length and a first enable signal having a length longer than the second enable signal which are generated from said timing signal, to generate an even-numbered edge for said pulse signal.

10. The write correction signal generation method as defined in claim 9 which includes an exclusive OR process which takes an exclusive OR of the outputs generated by said first and said second delay selection process and outputs a write correction timing signal.

11. The write correction signal generation method as defined in claim 10 which includes an output generation process for generating a write correction signal comprising a multipulse signal with using the both rising and falling edges of the output obtained in said exclusive OR process.

12. The write correction signal generation method as defined in claim 9, wherein in said first and said second delay selection processes respectively, said multiphase clock signal clock is made pass or held by said first enable signal having a length of two periods, and an edge of said multiphase clock signal is detected by said second enable signal having a length of one period.

13. The write correction signal generation method as defined in claim 9, wherein in said first and said second delay selection processes respectively, said multiphase clock signal is made pass or held by said first enable signal having a length of three periods, and an edge of said multiphase clock signal is detected by said second enable signal having a length of one period.

14. The write correction signal generation method defined in claim 9, wherein in said first and second delay selection processes respectively, said multiphase clock signal is made pass or blocked by said first enable signal having a length of three periods, and an edge of said multiphase clock signal is detected by said second enable signal having a length of one period.

15. The write correction signal generation method as defined in claim 13, wherein said second enabled signal having a length of one period is enabled with synchronized with one period at the center of said first enable signal having a length of three periods.

16. The write correction signal generating method as defined in claim 9, wherein said first and said second delay selecting processes respectively include a selection process for selecting a length of either two periods or three periods as the length of said first enable signal, said multiphase clock signal is made pass or held by said first enable signal having a length of two periods or three periods selected by the selection process, an edge of said multiphase clock signal is detected by said second enable signal having a length of one period.

17. The write correction circuit as defined in claim 6, wherein said second enable signal having a length of one period is enabled with synchronized with one period at the center of said first enable signal having a length of three periods.

18. The write correction signal generation method as defined in claim 14, wherein said second enabled signal having a length of one period is enabled with synchronized with one period at the center of said first enable signal having a length of three periods.
